(19) United States
(12) Patent Application Publication
(10) Pub. No.: US 2008/0053093 A1
(43) Pub. Date: Mar. 6, 2008

(54) Uniform pressure unequal surface engine and engine for power generators using the same

(76) Inventor: Chang Sun Kim, Incheon (KR)

Correspondence Address: STAAS & HALSEY LLP, SUITE 700, 1201 NEW YORK AVENUE, N.W., WASHINGTON, DC, 20005, US

(21) Appl. No.: 11/819,922

(22) Filed: Jun. 29, 2007

(30) Foreign Application Priority Data
Aug. 29, 2006 (KR) 10-2006-0082090
Aug. 29, 2006 (KR) 10-2006-0082108

(51) Int. Cl. F02G 3/02; F02B 25/04

(52) U.S. Cl. 60/620; 123/58.3; 123/65 R; 60/227

(57) ABSTRACT

Disclosed herein are a uniform pressure unequal surface engine and an engine for power generators using the same. The uniform pressure unequal surface engine includes a kernel cylinder having a fuel supply unit. A kernel piston is airtightly provided in the kernel cylinder and reciprocated by explosive force when fuel is burnt, thus providing rotating force to a rotating shaft. A pressure reducing cylinder is connected to the kernel cylinder via an openable exhaust gas pipe, has a relatively larger inner diameter than the kernel cylinder, and has no fuel supply unit. A pressure reducing piston has a relatively larger outer diameter so as to have a larger contact area with exhaust gas compared to the kernel piston, reciprocates in the pressure reducing cylinder while remaining airtight, and obtains power by acting with greater exhaust gas pressure on the pressure reducing piston because the pressure reducing piston has an area of contact with exhaust gas larger than that of the kernel piston when the exhaust gas pipe is opened. An air compressor inputs compressed air into the kernel cylinder when exhaust is being conducted from the kernel cylinder to the pressure reducing cylinder, thus pushing exhaust gas from the kernel cylinder into the pressure reducing cylinder, and providing new compressed air into the kernel cylinder.

### CROSS-REFERENCE TO RELATED APPLICATIONS

This application is based on and claims the priority from Korean Patent Application No. 10-2006-0082090, filed on Aug. 29, 2006 and No. 10-2006-0082108, filed on Aug. 29, 2006, in the Korean Intellectual Property Office, the disclosures of which are incorporated herein their entireties by reference.

### BACKGROUND

1. Field

The present invention relates generally to engines which burn fuel to obtain rotating force and, more particularly, to a uniform pressure unequal surface engine, which converts all of the pressure of high-pressure combustion gas, generated when fuel is burnt in a cylinder, into rotating force, and thereafter discharges exhaust gas having a pressure level similar to atmospheric pressure, and to an engine for power generators using the uniform pressure unequal surface engine.

2. Description of the Related Art

As well known to those skilled in the art, a positive-displacement internal-combustion engine, such as a diesel engine or a gasoline engine, uses combustion gas pressure among the combustion gas pressure and heat which are generated whenever fuel is burnt and exploded in a cylinder, thus obtaining rotating force. The residual combustion gas pressure and the residual heat are discharged to the outside. That is, only some of the explosive force generated by the combustion of the fuel in the cylinder is used to generate rotating force (power stroke), while the remaining explosive force is discharged to the outside together with discharge gas. At this time, the discharged exhaust gas has very high pressure, and thus noise and vibration are generated while the exhaust gas is discharged. Thus, the conventional positive-displacement internal-combustion engine must be additionally provided with a noise reduction device, such as a muffler, and must be constructed to reduce vibrations generated by high-pressure exhaust gas.

Further, although the exhaust gas of the conventional internal-combustion engine retains a large quantity of residual pressure and residual heat which are not used in the power stroke, the residual pressure is never used, and the residual heat is used as only a heat source, such as for a heating boiler. Recently, an insulated engine, which uses an insulating material, including ceramics, for the material of a combustion chamber of a piston, a cylinder, and other parts of a diesel engine or a gasoline engine, and is operated without cooling the engine, has been developed. Such an insulated engine reduces heat loss in the combustion chamber to increase exhaust energy, and reuses exhaust gas having high temperature for the heating boiler or the like. However, the insulated engine is problematic in that it cannot use the pressure remaining in the exhaust gas of the engine, in a principle using uniform pressure and unequal surfaces, to obtain rotating force, and cannot use heat to obtain rotating force but simply uses the heat to heat. However, the exhaust gas of the internal-combustion engine, used in a thermoelectric power plant which is located in a remote place which does not need a local heating system or where it is difficult to built a water pipe for the local heating system, is discharged to the atmosphere without additional treatment. Moreover, an additional cooling device must be provided to cool the heat of the internal-combustion engine.

### SUMMARY

Additional aspects and/or advantages will be set forth in part in the description which follows and, in part, will be apparent from the description, or may be learned by practice of the invention.

Accordingly, the present invention has been made keeping in mind the above problems occurring in the prior art, and an object of the present invention is to provide a uniform pressure unequal surface engine, which converts all of the high pressure of combustion gas, generated when fuel is burnt in a cylinder, into rotating force, and reduces the pressure of exhaust gas to the level of atmospheric pressure prior to discharging the exhaust gas to the outside, thus preventing the waste of energy and the generation of noise and vibration.

Another object of the present invention is to provide an engine for power generators using the uniform pressure unequal surface engine, which causes a cylinder of a positive-displacement internal-combustion engine to serve as a combustion chamber of an external-combustion engine as well as explosion space, thus converting all of the explosive energy and thermal energy, generated whenever fuel is burnt, into rotating force, in a principle using uniform pressure and unequal surfaces.

In order to accomplish the above objects, the invention provides a uniform pressure unequal surface engine, including a kernel cylinder having a fuel supply unit, a kernel piston which is airtightly provided in the kernel cylinder and is reciprocated by explosive force when fuel is burnt, thus providing rotating force to a rotating shaft, a pressure reducing cylinder which is connected to the kernel cylinder via an openable exhaust gas pipe, has a relatively larger inner diameter than the kernel cylinder, and has no fuel supply unit, a pressure reducing piston which has a relatively larger outer diameter so as to have a larger contact area with exhaust gas compared to the kernel piston, reciprocates in the pressure reducing cylinder while remaining airtight, and obtains power by acting with greater exhaust gas pressure on the pressure reducing piston because the pressure reducing piston has an area of contact with exhaust gas larger than that of the kernel piston when the exhaust gas pipe is opened, and an air compressor which inputs compressed air into the kernel cylinder when exhaust is being conducted from the kernel cylinder to the pressure reducing cylinder, thus pushing exhaust gas from the kernel cylinder into the pressure reducing cylinder, and providing new compressed air into the kernel cylinder.

According to an aspect of the invention, a ratio of an internal capacity of the kernel cylinder when the kernel piston is at a bottom dead center to an internal capacity of the pressure reducing cylinder when the pressure reducing piston is at a bottom dead center, and a ratio of an outer diameter of the kernel piston to an outer diameter of the pressure reducing piston are set such that an internal pressure of the pressure reducing cylinder becomes equal to atmospheric pressure when the pressure reducing piston is at the bottom dead center.

The invention provides an engine for power generators, including a uniform pressure unequal surface engine, a boiler heating water using heat of exhaust gas fed from the uniform pressure unequal surface engine, thus producing vapor, a steam engine extending a piston using pressure of the vapor fed from the boiler, and a vapor condenser collecting the vapor of the steam engine and condensing the vapor using refrigerant, prior to feeding the vapor back to the boiler.

In another aspect of the present invention, the refrigerant of the vapor condenser uses liquid having a lower boiling point than water, and a refrigerant gas engine is further connected to the vapor condenser and extends a piston using pressure of refrigerant gas which is evaporated by absorbing latent heat of condensation in the vapor condenser.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a view showing a stage where fuel is ignited in a kernel cylinder of a uniform pressure unequal surface engine, according to the present invention;

FIG. 2 is a view showing the state where the kernel cylinder of the uniform pressure unequal surface engine of the present invention is extended to bottom dead center;

FIG. 3 is a view showing the state where the kernel cylinder communicates with a pressure reducing cylinder after the kernel cylinder of the uniform pressure unequal surface engine of the present invention has reached bottom dead center;

FIG. 4 is a view showing a stage where exhaust gas is moved from the kernel cylinder of the uniform pressure unequal surface engine of the present invention to the pressure reducing cylinder, and air of an air compressor is simultaneously input to the kernel cylinder;

FIG. 5 is a view showing the construction of an engine for power generators using the uniform pressure unequal surface engine, according to the present invention;

FIG. 6a is a sectional view of the engine for power generators using the uniform pressure unequal surface engine, according to the preferred embodiment of the present invention;

FIG. 6b is a sectional view showing a refrigerant gas engine and a refrigerant gas condenser which may be further connected to a vapor condenser of the uniform pressure unequal surface engine of FIG. 6a; and

FIGS. 7a to 7k are sectional views showing the operation of the uniform pressure unequal surface engine of FIG. 6a, in stages.

### DETAILED DESCRIPTION OF THE EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

Hereinafter, a uniform pressure unequal surface engine according to the preferred embodiment of the present invention will be described in detail with reference to the accompanying drawings.

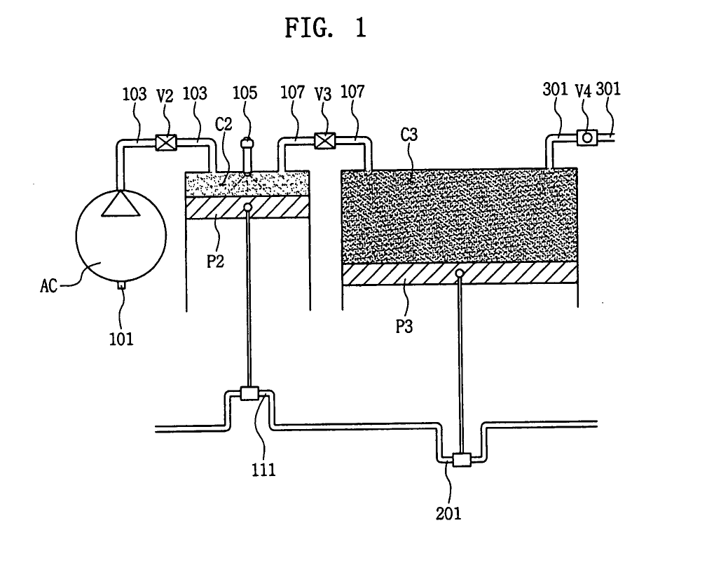

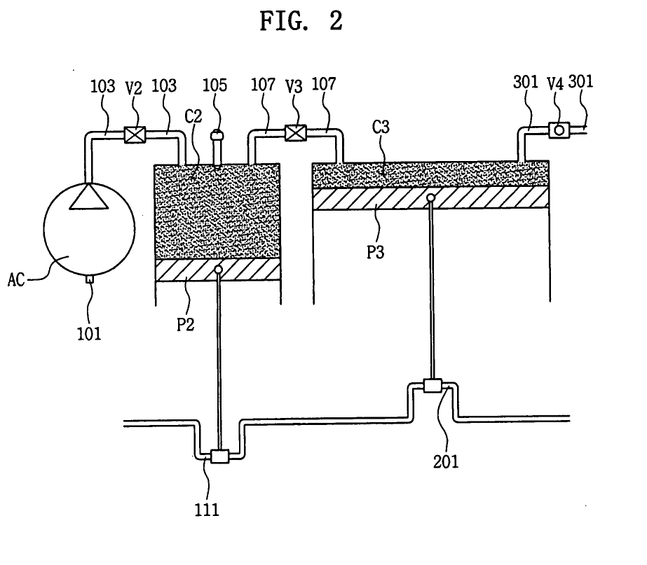

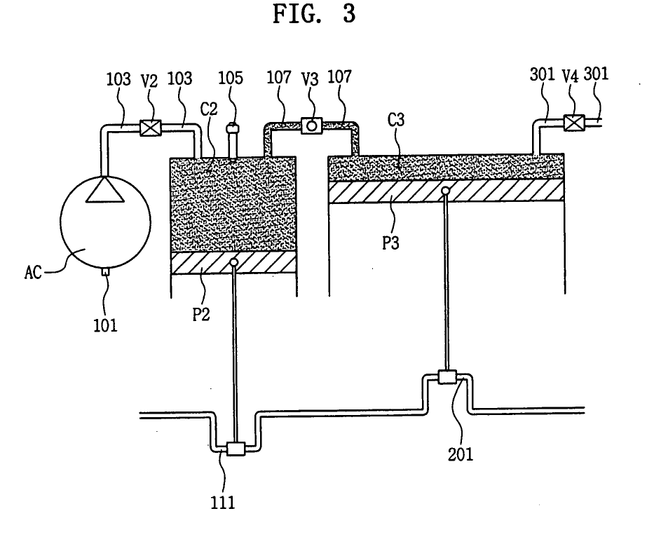

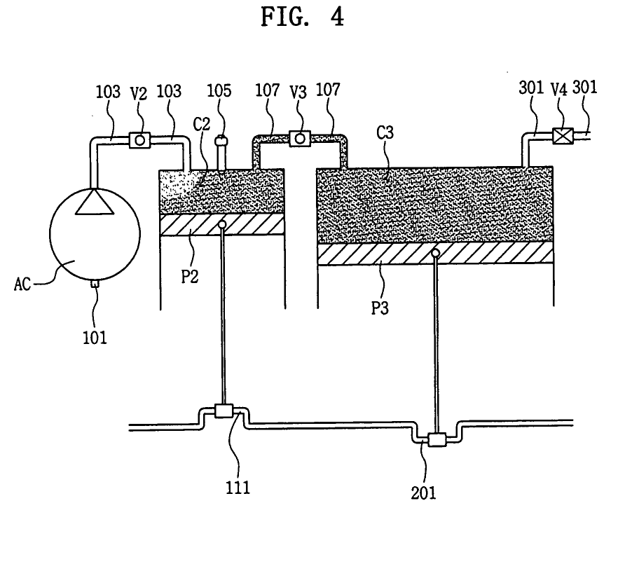

FIG. 1 is a view showing a stage where fuel is ignited in a kernel cylinder of a uniform pressure unequal surface engine, according to the present invention, FIG. 2 is a view showing the state where the kernel cylinder of the uniform pressure unequal surface engine of the present invention is extended to bottom dead center, FIG. 3 is a view showing the state where the kernel cylinder communicates with a pressure reducing cylinder after the kernel cylinder of the uniform pressure unequal surface engine of the present invention has reached bottom dead center, and FIG. 4 is a view showing a stage where exhaust gas is moved from the kernel cylinder of the uniform pressure unequal surface engine of the present invention to the pressure reducing cylinder, and air of an air compressor is simultaneously input to the kernel cylinder.

The term “uniform pressure unequal surface” used in the present invention means “the use of equal pressure and different sectional area” or “the use of the principle where equal-pressure fluid (gas or liquid) present in a hermetic space acts with a greater force on a movable part having a larger area of contact with the fluid”. The term “in a principle using uniform pressure and unequal surfaces” used herein means “using the principle where equal-pressure fluid (gas or liquid) present in a hermetic space acts with a greater force on a movable part having a larger area of contact with the fluid”.

Further, the term “comparatively larger diameter” used herein means a relatively larger diameter, when the inner diameter of a cylinder or the outer diameter of a piston is compared with the inner diameter of another cylinder or the outer diameter of another piston.

Referring to FIG. 1, the uniform pressure unequal surface engine according to the present invention includes two engine units which are connected to each other by an exhaust gas pipe 107. One of the two engine units includes a kernel cylinder C2 which has a fuel supply unit, such as an injector 105, and a kernel piston P2 which is reciprocated in the kernel cylinder C2 by explosive force, generated when fuel is burnt, while remaining airtight, thus providing rotating force to rotating shafts 111 and 201. The other engine unit has a pressure reducing cylinder C3 and a pressure reducing piston P3. The pressure reducing cylinder C3 has an inner diameter larger than that of the kernel cylinder C2, and has no fuel supply unit. The pressure reducing piston P3 has an outer diameter larger than that of the kernel cylinder C2 so as to have a larger area of contact with exhaust gas, and is installed to reciprocate in the pressure reducing cylinder C3 while remaining airtight. When the exhaust gas pipe 107 is opened, exhaust-gas pressure larger than that of the kernel piston P2 acts on the pressure reducing piston P3, because the pressure reducing piston P3 has an area of contact with exhaust gas larger than that of the kernel piston P2. In this way, the pressure reducing piston P3 obtains power.

The exhaust gas pipe 107 is opened or closed by means of a Valve V3. Although simply shown in FIGS. 1 to 4, actually, the operation of opening or closing the valve V3 is conducted by a cam, a solenoid, etc. which is operated in conjunction with the rotating shafts 111 and 201.

The pressure reducing cylinder C3 is provided with another exhaust gas pipe 301, in addition to the exhaust gas pipe 107. A valve V4 is also provided on the exhaust gas pipe 301 and is operated by the cam or the solenoid, which is operated in conjunction with the rotating shafts 111 and 201. The exhaust gas pipe 301 communicates with the atmosphere.

As will be described later in detail, when gas is being exhausted from the kernel cylinder C2 to the pressure reducing cylinder C3, compressed air is input into the kernel cylinder C2 to push the exhaust gas from the kernel cylinder C2 into the pressure reducing cylinder C3 and new compressed air is provided to the interior of the kernel cylinder C2. To this end, an air compressor AC is provided to be connected to the kernel cylinder C2 via an air pipe 103. An air inlet port 101 of the air compressor AC communicates with the atmosphere. In FIGS. 1 to 4, the air compressor is simply denoted by reference character AC. Preferably, the air compressor AC includes a cylinder and a piston, and is operated in conjunction with the rotation of the rotating shafts.

The kernel cylinder C2, the kernel piston P2, and the air compressor AC, which suck the air and the fuel so that the fuel is exploded and obtains rotating force from the explosive force, are referred to as a combustion unit. The pressure reducing cylinder C3 and the pressure reducing piston P3, which generate rotating force using the exhaust gas of the kernel cylinder C2, in a principle using uniform pressure and unequal surfaces, and exhaust the remaining pressure of the exhaust gas, are referred to as a pressure reducing unit.

Preferably, the uniform pressure unequal surface engine according to the present invention comprises a two-stroke cycle engine unit. In this case, the combustion unit of the uniform pressure unequal surface engine according to the present invention includes the two-stroke cycle engine unit C2 and P2 and the air compressor AC. The two-stroke cycle engine unit C2 and P2 injects the fuel into the compressed air in the kernel cylinder C2 every two strokes and explodes the piston using the explosive force generated when the fuel is burnt. The air compressor AC is installed to be parallel to the two-stroke cycle engine unit C2 and P2, and is connected to an intake port of the two-stroke cycle engine unit C2 and P2 via the air pipe 103. Thereby, the air compressor AC sucks and compresses external air, prior to inputting the compressed air into the two-stroke cycle engine unit C2 and P2 every two strokes. Through such a construction, the two-stroke cycle engine unit C2 and P2 sequentially performs the exhaust and the intake of air, the discharge of the exhaust gas, and the compression in one stroke, and burns and expands the fuel in the other stroke. Since the gas of the two-stroke cycle engine unit C2 and P2 is not directly discharged to the atmosphere, but is used under high pressure in the pressure reducing unit, it is difficult for the exhaust gas to be completely discharged from the kernel cylinder C2 of the two-stroke cycle engine unit at the exhaust stage. Meanwhile, when the top-dead center of the piston is designed to be high in order to completely discharge the exhaust gas from the two-stroke cycle engine unit C2 and P2, the compression ratio of the air may become excessively high. Thus, the present invention adopts the two-stroke cycle engine unit C2 and P2, which performs the exhaust, the intake of air, the discharge of exhaust gas, and compression in one stroke, and compresses and inputs the air while gas is being discharged by the air compressor AC. Through such a construction, when the exhaust stage of the two-stroke cycle engine unit C2 and P2 is almost finished, the air input from the air compressor AC forcefully pushes the exhaust gas, which is being discharged from the kernel cylinder C2 of the two-stroke cycle engine unit, so that all of the exhaust gas is discharged without remaining in the cylinder C2. The intake of air into the kernel cylinder C2 of the two-stroke cycle engine unit and the discharge of the exhaust gas out of the kernel cylinder C2 are controlled by a valve V2 of the air pipe 103 and the valve V3 of the exhaust gas pipe in the two stroke cycle.

The pressure reducing unit C3 and P3, which is operated by the remaining pressure of the exhaust gas without the additional combustion of fuel, is connected to a position adjacent to the two-stroke cycle engine unit C2 and P2. The intake port of the pressure reducing unit C3 and P3 is connected to an exhaust port of the two-stroke cycle engine unit via the exhaust gas pipe 107. The present invention is characterized in that the inner diameter of the pressure reducing cylinder C3 of the pressure reducing unit C3 and P3 and the diameter of the pressure reducing piston P3 are larger than the inner diameter of the kernel cylinder C2 and the diameter of the kernel piston P2 of the two-stroke cycle engine unit C2 and P2, respectively. This is expressed as “comparatively larger diameter” in the specification and claims of the invention. That is, the comparatively larger diameter means that the inner diameter of the cylinder and the diameter of the piston of the second engine unit, into which gas retaining pressure is input from the first engine unit, are larger than the inner diameter of the cylinder and the diameter of the piston of the first engine unit.

If the ratio of the internal capacity of the kernel cylinder C2 when the kernel piston P2 reaches bottom dead center to the internal capacity of the pressure reducing cylinder C3 when the pressure reducing cylinder P3 reaches bottom dead center and the ratio of the outer diameter of the kernel piston P2 to the outer diameter of the pressure reducing piston P3 are set so that the internal pressure of the pressure reducing cylinder rC3 is equal to atmospheric pressure when the pressure reducing piston P3 reaches bottom dead center, no noise or vibration is generated when the exhaust gas is discharged from the pressure reducing cylinder C3 through the exhaust gas pipe 301.

The operation of the uniform pressure unequal surface engine according to the present invention will be described below with reference to the accompanying drawings.

As shown in FIGS. 1 and 2, while the fuel is burnt in the kernel cylinder C2, heat and expansion pressure are instantaneously generated. By the heat and expansion pressure, the kernel cylinder P2 moves downwards, so that rotating force is obtained. As shown in FIG. 3, when the kernel piston P2 reaches bottom dead center (the lowermost position), the valve V3 of the exhaust gas pipe 107 is opened. At this time, the pressure of the combustion gas remaining in the kernel cylinder C2 is uniformly transmitted to the pressure reducing cylinder C3. Since the sectional area (the outer diameter of the pressure reducing piston or the contact area with the exhaust gas) of the pressure reducing piston P3 is extended compared to the kernel piston P2, in proportion to the dimension of the pressure remaining in the kernel cylinder C2, the downward pressure of the pressure reducing piston P3 is higher than the downward pressure of the kernel piston P2 even under equal pressure. Thus, when the pressure reducing piston P3 moves downwards, rotating force is generated. As shown in FIG. 1, when the pressure reducing piston P3 reaches bottom dead center (the lowermost position), the remaining pressure disappears, and the kernel piston P2 reaches the uppermost position. When the kernel piston P2 reaches the uppermost position, the fuel is burnt and exploded again in the kernel cylinder C2, thus repeatedly generating rotating force.

The present invention uses the principle where energy is transmitted in the direction having the larger sectional area, that is, one of the two pistons P2 and P3 under equal pressure. In order to ensure easy transfer of energy, the kernel piston P2 and the pressure reducing piston P3 conduct opposite motion. Thereby, when the kernel piston P2 is at top dead center, the pressure reducing piston P3 is at bottom dead center. Conversely, when the kernel piston P2 is at bottom dead center, the pressure reducing piston P3 is at top dead center. In this way, rotating force is obtained. Here, the sectional area of the pressure reducing piston P3 is formed to be large in proportion to the pressure remaining in the kernel cylinder C2. Thus, the first expansion pressure provides power to the kernel piston P2, and the pressure of the combustion gas (exhaust gas), which is not used to move the kernel piston P2 but remains, is transferred to the pressure reducing piston P3, and provides pressure to the pressure reducing piston P3. The pressure of the exhaust gas acts on the pressure reducing piston P3 until the exhaust-gas pressure in the pressure reducing cylinder C3 is equal to atmospheric pressure. Thus, the sectional area of the pressure reducing piston P3 is designed such that the exhaust-gas pressure of the pressure reducing cylinder C3 corresponds to atmospheric pressure when the pressure reducing cylinder C3 is at bottom dead center, in consideration of the exhaust-gas pressure of the kernel cylinder C2. In this case, little energy is consumed in order to discharge the exhaust gas from the pressure reducing cylinder C3. In addition, hardly any noise or vibration is generated. Thereby, all of the pressure generated when the fuel is burnt and exploded in the kernel cylinder C2 is converted into rotating force without loss.

The operation of the uniform pressure unequal surface engine according to the present invention will be described more concretely below.

FIG. 1 shows the stage where the fuel is injected into the compressed air using the fuel injector 105. At this time, the valve V2 of the air pipe 103 and the valve V3 of the exhaust gas pipe 107 are closed. FIG. 2 shows the expansion stage of the two-stroke cycle engine unit C2 and P2. As such, in the engine according to the present invention, the fuel is burnt in only one engine unit. FIG. 3 shows the stage where the valve V3 of the exhaust gas pipe is opened and the exhaust gas is discharged to the pressure reducing cylinder C3 of the pressure reducing unit, when the kernel piston P2 of the two-stroke cycle engine unit passes through bottom dead center and moves upwards. As soon as the exhaust gas pipe 107 is opened, the exhaust gas is input into the pressure reducing cylinder C3 of the pressure reducing unit C3 and P3 having the comparatively larger diameter under high temperature and high pressure, so that the exhaust gas pushes downwards the pressure reducing piston P3 of the pressure reducing unit C3 and P3 having the comparatively larger diameter. This is because, when the exhaust gas pipe 107 is opened, the internal pressure of the kernel cylinder C2 of the two-stroke cycle engine unit becomes equal to the internal pressure of the pressure reducing cylinder C3 of the pressure reducing unit, and the greater pressure of the exhaust gas acts on the pressure reducing piston (piston having a comparatively larger diameter) which is larger than the diameter of the kernel piston P2 of the two-stroke cycle engine unit, that is, has a wider contact area with the exhaust gas. This obeys the principle where kinetic energy moves toward a movable part having a larger contact area when fluid having equal pressure acts on movable parts having different contact areas. To this end, when the kernel piston P2 of the two-stroke cycle engine unit is at bottom dead center, the pressure reducing piston P3 of the pressure reducing unit C3 and P3 having the comparatively larger diameter must be at top dead center. Further, at this stage, the valve V4 for the exhaust gas pipe of the pressure reducing unit C3 and P3 is closed. FIG. 4 shows the stage where the valve V2 of the air pipe 103 is opened, the combustion gas is pushed, and the compression of air is performed again, in the state where some of the combustion gas is discharged from the kernel cylinder C2 of the two-stroke cycle engine unit. When the stage of FIG. 4 has been completed, the stage of FIG. 1 is restarted.

During such a process, the explosive energy (high pressure) and the thermal energy (high temperature) generated when the fuel is burnt in the kernel cylinder C2 are converted into rotating force, directly or in a principle using uniform pressure and unequal surfaces.

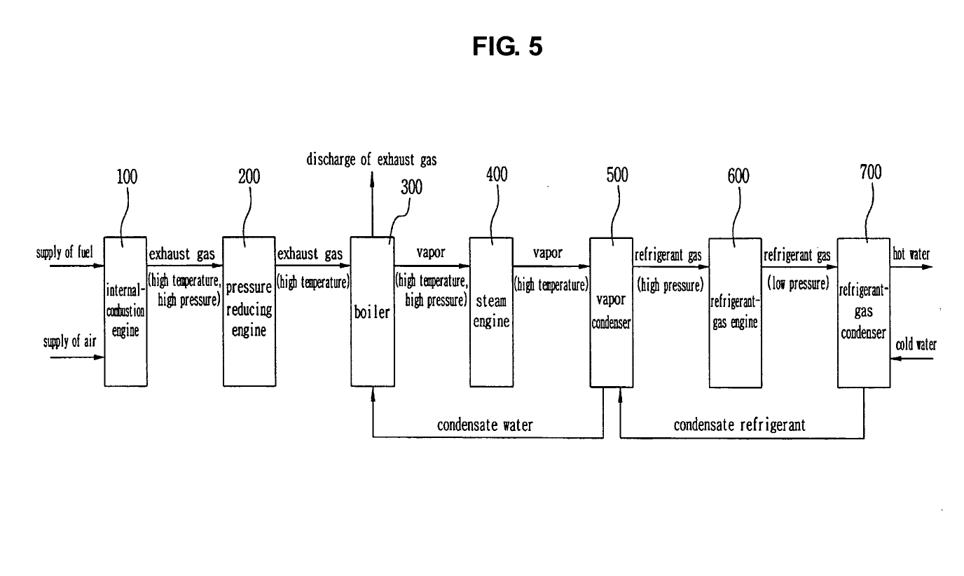

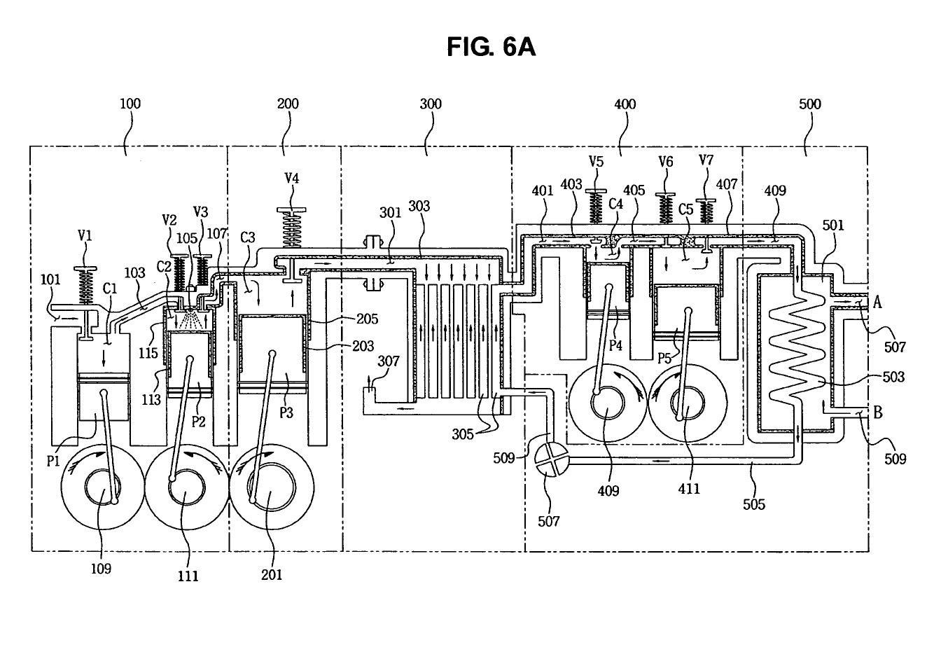

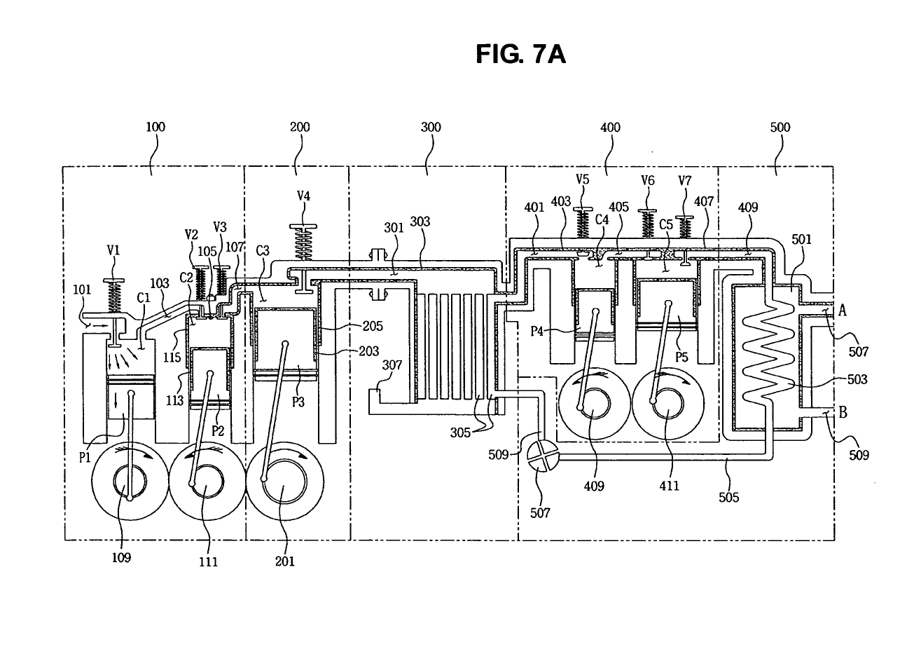

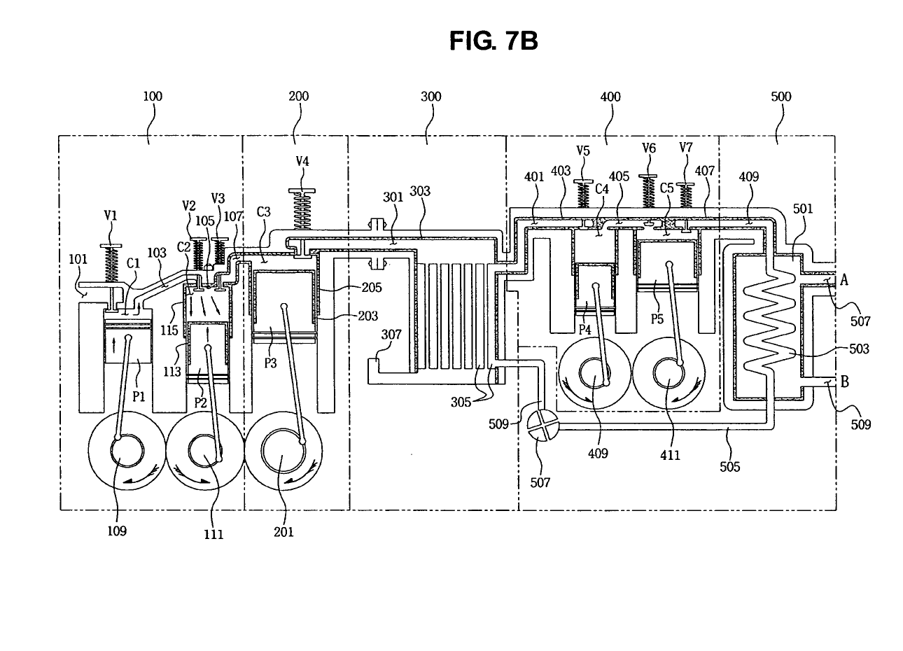

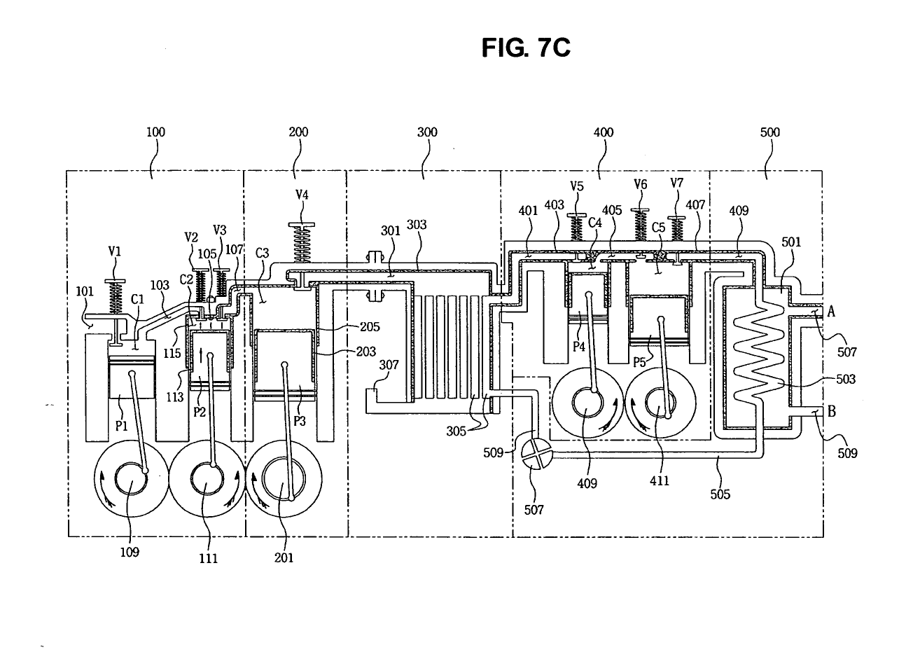

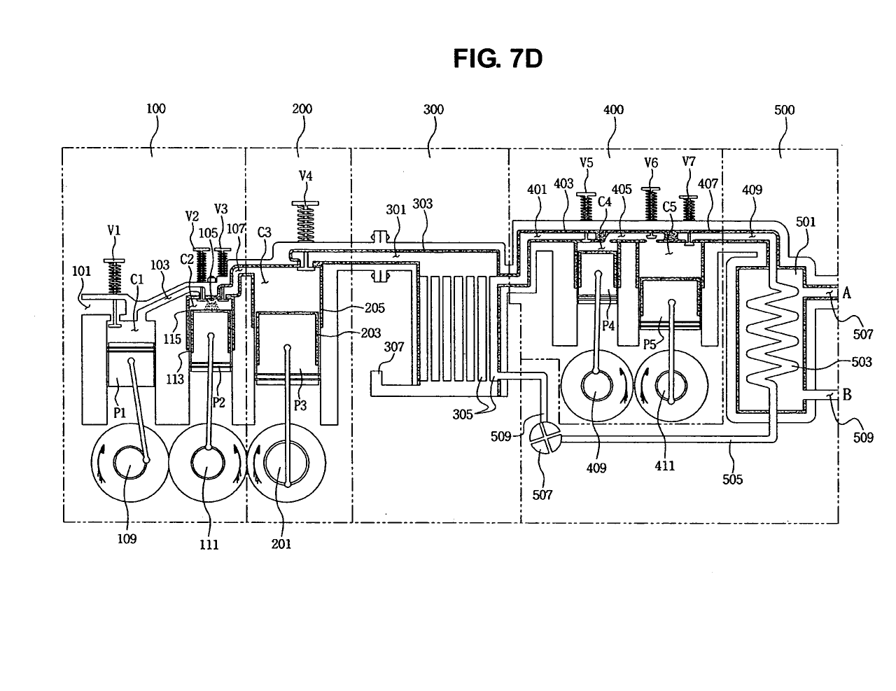

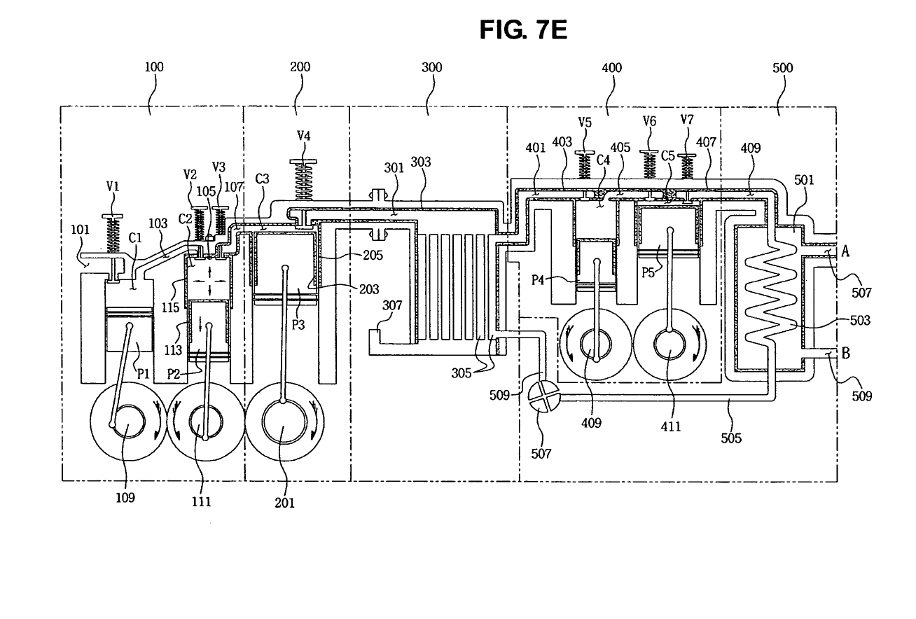

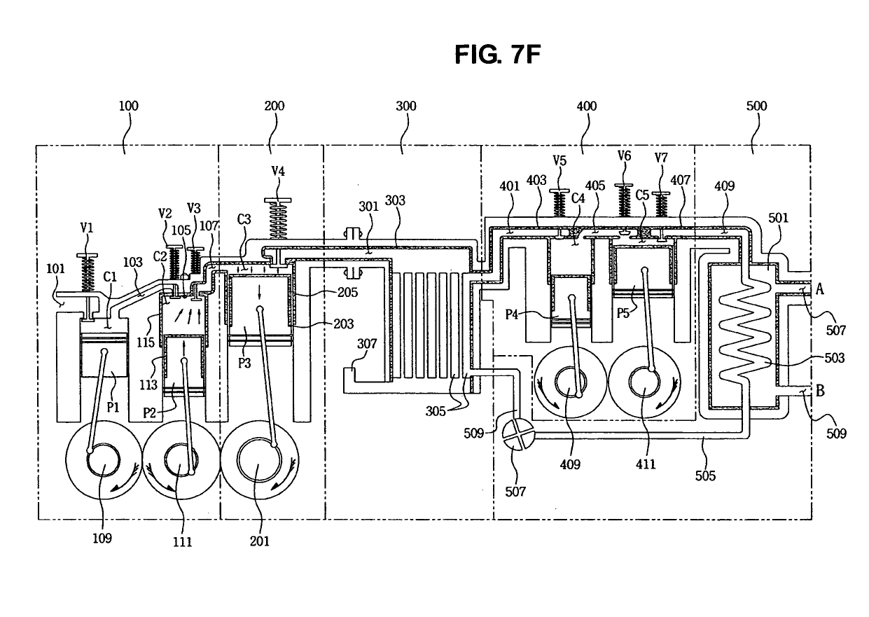

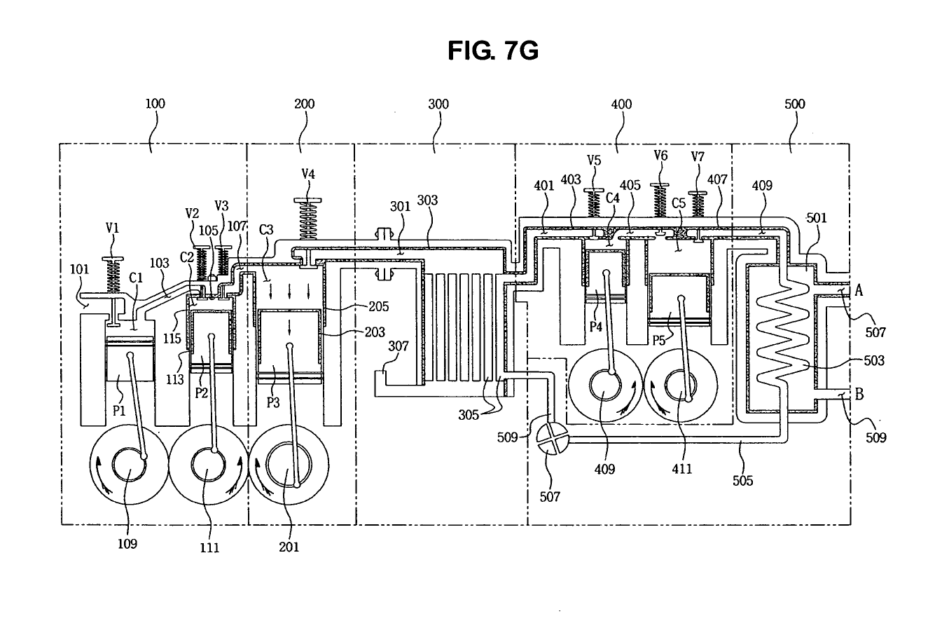

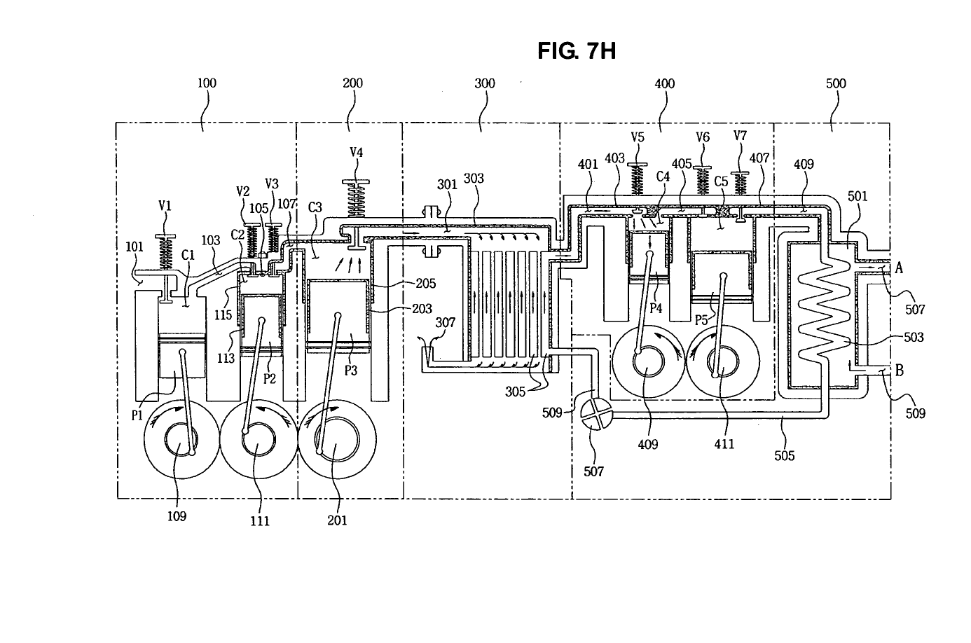

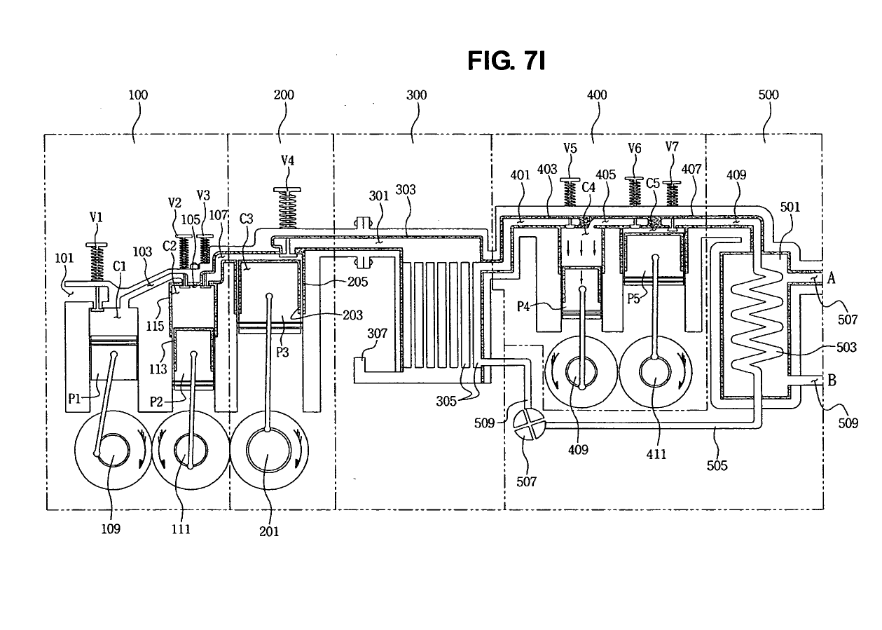

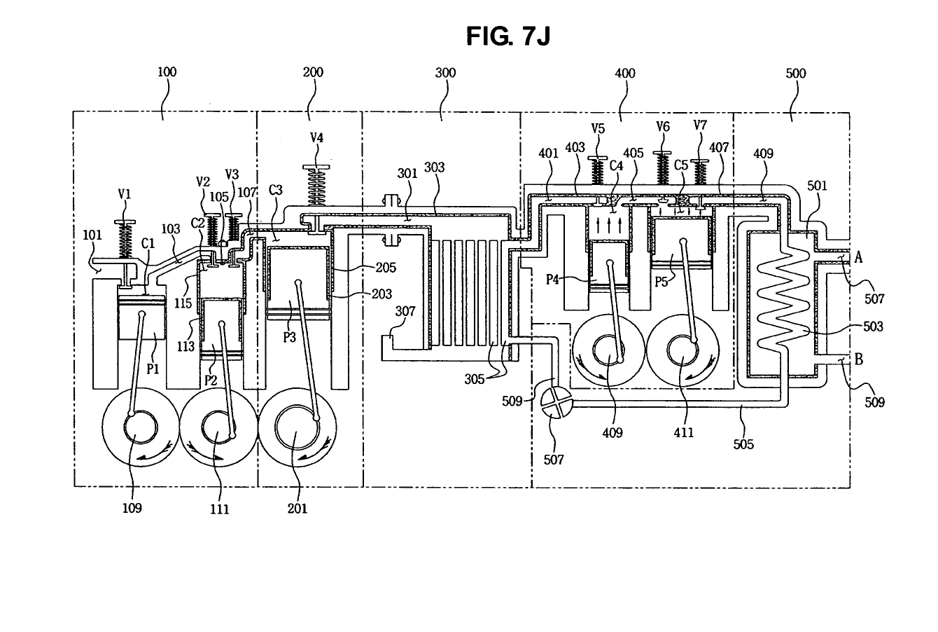

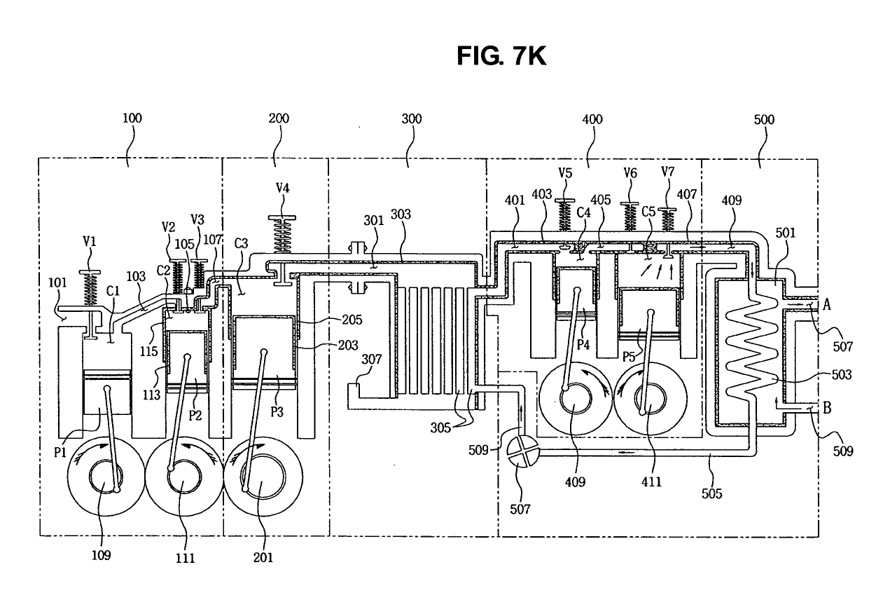

FIG. 5 is a view showing the construction of an engine for power generators using the uniform pressure unequal surface engine, according to the present invention, FIG. 6a is a sectional view of the engine for power generators using the uniform pressure unequal surface engine, according to the preferred embodiment of the present invention, FIG. 6b is a sectional view showing a refrigerant gas engine and a refrigerant gas condenser which may be further connected to a vapor condenser of the uniform pressure unequal surface engine of FIG. 6a, and FIGS. 7a to 7k are sectional views showing the operation of the uniform pressure unequal surface engine of FIG. 6a, in stages.

Referring to FIG. 5, according to the present invention, fuel is burnt and exploded in an internal-combustion engine 100 to produce combustion gas having high temperature and high pressure. First, the explosive force is converted into rotating force in the internal-combustion engine 100. Thereafter, the exhaust gas, which has high temperature and high pressure and is discharged from the internal-combustion engine 100, is input into a pressure reducing engine 200 connected to the internal-combustion engine 100, so that the remaining explosive force of the exhaust gas is converted into rotating force again, in a principle using uniform pressure and unequal surfaces. Further, the heat of the hot exhaust gas, which is discharged from the pressure reducing engine 200, is converted into rotating force in a steam engine 400 and a refrigerant gas engine 600 again. That is, the present invention is characterized in that fuel is burnt and exploded in a single internal-combustion engine 100, so that rotating force can be obtained in an external-combustion engine, including the pressure reducing engine 200, the steam engine 400, and the refrigerant gas engine 600, as well as the internal-combustion engine 100. In order to obtain rotating force from the hot exhaust gas discharged from the pressure reducing engine 200, the hot exhaust gas is input into a boiler 300, so that vapor having high temperature and high pressure is generated from the heat of the exhaust gas. Further, the vapor having high temperature and high pressure is input into the steam engine 400, so that the pressure of the vapor is converted into rotating force. The exhaust gas of the internal-combustion engine 100 primarily loses pressure in the pressure reducing engine 200, and secondarily loses heat in the boiler 300, prior to being finally discharged to the outside.

As will be described below in detail, according to the present invention, the pressure reducing engine 200 uses the exhaust gas, in a principle using uniform pressure and unequal surfaces, thus obtaining rotating force. The steam engine 400 and the refrigerant gas engine 600 primarily use the pressure of the vapor or the refrigerant gas, thus obtaining rotating force. Thereafter, rotating force is obtained using the remaining pressure of the vapor or refrigerant gas, in a principle using uniform pressure and unequal surfaces.

Moreover, as shown in FIG. 5, the vapor which transmits the pressure to the steam engine 400 is input into a vapor condenser 500, so that refrigerant is heated using the remaining heat, and thus refrigerant gas having high pressure is obtained. The refrigerant gas having the high pressure is input into the refrigerant gas engine 600, so that the pressure can be converted into rotating force. In this case, condensate water condensed in the vapor condenser 500 is fed back to the boiler 300 by a pump. Further, the refrigerant gas which has low pressure and is discharged from the refrigerant-gas engine 600 is condensed in a refrigerant gas condenser 700, and is fed back to the vapor condenser 500 by the pump.

In such a process, the combustion chamber of the internal-combustion engine 100 serves as a fuel combustion chamber to provide explosive force to the internal-combustion engine 100, in addition to serving as a fuel combustion chamber to provide required heat to the external-combustion engine 200, 400, and 600. Thus, all of the explosive energy (high pressure) and thermal energy (high temperature) generated when the fuel is burnt in the internal-combustion engine 100 are converted into rotating force, directly or in a principle using uniform pressure and unequal surfaces, thus maximizing the fuel efficiency of the engine for power generators.

The embodiment of FIGS. 6a and 7k more concretely shows the engine for power generators using the uniform pressure unequal surface engine of FIG. 5. FIG. 6a illustrates only the internal-combustion engine 100, the pressure reducing engine 200, the boiler 300, the steam engine 400, and the vapor condenser 500, among the units which constitute the present invention and are shown in FIG. 5. FIG. 6b additionally illustrates the refrigerant gas engine 600 and the refrigerant gas condenser 700, which may be further connected to the vapor condenser 500. Further, since the operating principle of the refrigerant gas engine 600 and the refrigerant gas condenser 700 is equal to the operating principle of the boiler 300 and the steam engine 400, except that refrigerant gas is evaporated in the vapor condenser 500 in place of the boiler 300, FIGS. 7a to 7k, illustrating the operation of the present invention show only units other than the refrigerant gas engine 600 and the refrigerant gas condenser 700. Although FIGS. 6a to 7k show rotating shafts connected to each other with gears, this is only for convenience. Actually, pistons of neighboring units are connected to the same crank shaft via a connecting rod.

Referring to FIG. 6a, the present invention is characterized by the construction of the internal-combustion engine. That is, the internal-combustion engine 100 of the present invention must have a construction capable of efficiently serving as the combustion chamber of external-combustion engine 200, 400, and 600, in addition to serving as the internal-combustion engine. To this end, according to the present invention, the internal-combustion engine 100 includes a two-stroke cycle engine unit C2, P2, V2, V3, and 111, and an air compressor unit C1, P1, V1, and 109. The two-stroke cycle engine unit C2, P2, V2, V3, and 111 injects fuel into compressed air every two strokes in the kernel cylinder C2, and extends the piston using the explosive force of the fuel. The air compressor unit C1, P1, V1, and 109 is installed to be parallel to the two-stroke cycle engine unit C2, P2, V2, V3, and 111, and is connected to an intake port of the two-stroke cycle engine unit via an air pipe 103. Thereby, the air compressor unit C1, P1, V1, and 109 draws external air into the cylinder C1 through an intake pipe 101 every two strokes, and then compresses the external air using a piston P1, prior to inputting the compressed air into the two-stroke cycle engine unit C2, P2, V2, V3, and 111. Through such a construction, the two-stroke cycle engine unit C2, P2, V2, V3, and 111 sequentially performs exhaust, the intake of air, and compression in one stroke, and performs combustion and expansion in the other stroke. Since the kernel cylinder C2 of the two-stroke cycle engine unit performs the function of the combustion chamber of the external engine 200, 400, and 600, as well as the function of the burning and exploding chamber of the internal-combustion engine 100, the combustion gas must remain in the kernel cylinder C2 for as little time as possible after the fuel is burnt and exploded, thus minimizing the loss of heat in the kernel cylinder C2. Simultaneously, the exhaust gas of the internal-combustion engine 100 is not directly discharged to the atmosphere but is used under high pressure in the pressure reducing engine. Thus, a means for completely discharging the exhaust gas from the kernel cylinder C2 of the two-stroke cycle engine unit at the exhaust stage is required. Therefore, the present invention adopts a two-stroke cycle engine unit C2, P2, V2, V3, and 111, which performs the exhaust, the intake and compression of the air in one stroke, and compresses and inputs the air using the air compressor unit C1, P1, V1, and 109 while the exhaust operation is being conducted. Through such a construction, when the exhaust operation of the two-stroke cycle engine unit C2, P2, V2, V3, and 111 is almost finished, the air input from the air compressor unit C1, P1, V1, and 109 strongly pushes exhaust gas which is being discharged from the kernel cylinder C2 of the two-stroke cycle engine unit. Thereby, all of the exhaust gas is discharged without remaining in the cylinder. If top dead center of the piston is designed to be high so as to completely discharge the exhaust gas in the two-stroke engine unit, the compression ratio of the air may be excessively high. Conversely, if top dead center of the piston is designed to be low, the exhaust gas cannot be smoothly discharged. However, the above-mentioned construction allows the exhaust gas to be completely discharged from the kernel cylinder C2 where combustion occurs, even though top dead center of the piston of the two-stroke cycle engine unit C2, P2, V2, V3, and 111 is set so that it is not so high that it causes excessive compression. The intake of air into the kernel cylinder C2 of the two-stroke cycle engine unit and the discharge of exhaust gas out of the kernel cylinder C2 are controlled in the two-stroke cycle by the intake valve V2 and the exhaust valve V3. Further, the intake of air into the cylinder of the air compressor unit is controlled in the two-stroke cycle by the intake valve V1, and the discharge of air from the cylinder C1 of the air compressor unit to the kernel cylinder C2 of the two-stroke cycle engine unit is controlled only by the intake valve V2 of the kernel cylinder C2 of the two-stroke cycle engine unit.

The pressure reducing engine 200 is connected to a portion adjacent to the two-stroke cycle engine unit C2, P2, V2, V3, and 111, and is operated by the remaining pressure of the exhaust gas without the consumption of additional fuel. An intake port of the pressure reducing engine 200 is connected to an exhaust port of the two-stroke cycle engine unit via an exhaust gas pipe 107. The present invention is characterized in that the inner diameter of the pressure reducing cylinder C3 of the pressure reducing engine 200 and the diameter of the pressure reducing piston P3 are larger than the inner diameter of the kernel cylinder C2 and the diameter of the kernel piston P2 of the two-stroke cycle engine unit C2, P2, V2, V3, and 111. This is referred to as “comparatively larger diameter” in the specification and claims of the present invention. That is, the comparatively larger diameter means that the inner diameter of the cylinder and the diameter of the piston of the second engine unit, into which gas retaining pressure is input from the first engine unit, are larger than the inner diameter of the cylinder and the diameter of the piston of the first engine unit. The pressure reducing cylinder C3 of the pressure reducing engine 200 having the comparatively larger diameter is not provided with an additional intake valve V4, and the intake operation is controlled by the exhaust valve V3 of the kernel cylinder C2 of the two-stroke cycle engine unit. The exhaust operation of the pressure reducing cylinder C3 of the pressure reducing engine having the comparatively larger diameter is controlled by the exhaust valve V4 provided in the exhaust port in a two-stroke cycle.

The pressure reducing engine 200 is connected to the boiler 300. The exhaust gas of the pressure reducing engine 200 is input into the boiler 300, so that the boiler 300 heats water, and thus generates vapor having high temperature and high pressure. After the exhaust gas discharged from the pressure reducing engine 200 is fed through the exhaust gas pipe 301 to the boiler 300, the exhaust gas passes between boiler pipes 305 of the boiler 300, and heats water passing through the boiler pipes 305, thus producing vapor having high temperature and high pressure. The exhaust gas which loses its heat is discharged through an exhaust pipe 307 to the outside. The pressure reducing engine 200 eliminates expansive force remaining in the exhaust gas of the internal-combustion engine 100, and realizes exhaust gas having low pressure and high temperature, prior to inputting the exhaust gas into the boiler 300.

The boiler 300 is connected to the steam engine 400. Vapor is fed from the boiler 300 to the steam engine 400, so the piston of the steam engine 400 is extended by the pressure of the vapor. As shown in FIG. 6a, the steam engine 400 preferably has a first steam engine unit C4, P4, V5, and 409 and a second steam engine unit C5, P5, V6, and V7. The first steam engine unit C4, P4, V5, and 409 opens an intake valve V5 every two strokes, and extends a piston P4 using vapor fed from the boiler 300 to the cylinder C4. The second steam engine unit C5, P5, V6, and V7 extends a piston P5 having a comparatively larger diameter using vapor which is discharged from the first steam engine unit C4, P4, V5, and 409 and input into a cylinder C5 having a comparatively larger diameter. The cylinder C4 of the first steam engine unit is not provided with an additional exhaust valve, and the operation of discharging vapor from the cylinder C4 of the first steam engine unit to the cylinder C5 of the second steam engine unit having a comparatively larger diameter is controlled by an intake valve V6 of the second steam engine unit. The cylinder C5 of the second steam engine unit having a large comparison diameter is further provided with an exhaust valve V7 to control the discharge of vapor.

The steam engine 400 is connected to a vapor condenser 500, which collects the vapor of the steam engine 400, condenses the vapor using refrigerant, and then feeds the condensed vapor back to the boiler 300. The vapor condenser 500 includes a condensing tank 501 which is filled with refrigerant liquid and a condensing pipe 503 which is immersed in the refrigerant liquid and condenses the vapor while passing through the vapor. The condensing pipe 503 is connected to the boiler pipe 305 via condensate water pipes 505 and 509. A pump 507 is provided on the condensate water pipes 505 and 509 to circulate condensate water.

Portion A of FIG. 6b is connected to portion A of FIG. 6a, and portion B of FIG. 6b is connected to portion B of FIG. 6a. Referring to FIG. 6b, the refrigerant of the vapor condenser 500 uses liquid having a boiling point which is lower than water, such as propane or alcohol. The refrigerant gas engine 600 may be further connected to the vapor condenser 500. The vapor condenser 500 absorbs the latent heat of condensation and produces evaporated refrigerant gas. The evaporated refrigerant gas is input into the refrigerant gas engine 600, and a piston P6 of the refrigerant gas engine 600 is extended by the pressure of the evaporated refrigerant gas. The experiment shows that propane gas having about 20 atm can be obtained within a short period of time, when propane liquid is heated to 100° C. in a sealed space. The refrigerant gas engine 600 obtains rotating force using the pressure.

The refrigerant gas engine 600 includes a first refrigerant gas engine unit C6, P6, V8, and 609 and a second refrigerant gas engine unit C7, P7, V9, V10, and 611. The first refrigerant gas engine unit C6, P6, V8, and 609 opens an intake valve every two strokes, and extends a piston using refrigerant gas which is fed from the condensing tank of the vapor condenser into a cylinder. The second refrigerant gas engine unit C7, P7, V9, V10, and 611 extends a piston having the comparatively larger diameter using refrigerant gas which is discharged from the first refrigerant gas engine unit C6, P6, V8, and 609 and is input into a cylinder. Other constructions and operations of the refrigerant gas engine 600 are equal to those of the steam engine 500.

The refrigerant gas engine 600 is connected to a refrigerant gas condenser 700. The refrigerant gas condenser 700 collects vapor of the refrigerant gas engine 600, and condenses the vapor using cooling water, prior to feeding the condensed vapor back to the condensing tank 501 of the vapor condenser 500. The refrigerant gas condenser 700 includes a condensing tank 701 which is filled with cooling water, and a condensing pipe 703 which is immersed in the cooling water and condenses the refrigerant gas while passing through the refrigerant gas. The condensing pipe 703 is connected to the condensing tank 501 of the vapor condenser 500 via condensing refrigerant pipes 705 and 709. A pump 707 is provided on the condensing refrigerant pipes 705 and 709 to circulate the condensing refrigerant.

According to the present invention, since the heat generated when the fuel is burnt in the kernel cylinder C2 of the internal-combustion engine 100 converts rotating force in the steam engine 400 and the refrigerant gas engine 600, it is necessary to surround the path, which extends from the kernel cylinder C2 of the internal-combustion engine 100 to the refrigerant gas engine 600 and in which exhaust gas, vapor, or refrigerant gas stays or moves, with pieces of insulating material 113, 115, 203, 205, 303, 403, and 603. Thus, the pieces of insulating material 113, 115, 203, 205, 303, 403, and 603 are attached to the inner walls of the cylinders C1 to C7 of the two-stroke cycle engine unit C2, P2, V2, V3, and 111, the pressure reducing engine 200, the boiler 300, the steam engine 400, or the refrigerant gas engine 600, the outer walls of the pistons P1 to P7, the inner walls of the exhaust gas pipes 107 and 301, the inner walls of the vapor pipes 401 and 409, and the inner walls of the refrigerant gas pipes 601, 605, and 607. Thereby, the combustion gas, the exhaust gas, the vapor, and the refrigerant gas always contact the pieces of insulating material throughout the entire stroke range of each unit.

The operation of the engine for power generators using the uniform pressure unequal surface engine according to the present invention will be described below with reference to FIGS. 7a to 7k.

FIG. 7a shows the stage where the intake valve V1 of the air compressor of the internal-combustion engine 100 is opened, and the piston P1 moves from top dead center to bottom dead center, thus drawing external air into the cylinder C1. FIG. 7b shows the stage where the intake valve V1 of the air compressor is closed, and the piston P1 of the air compressor moves from bottom dead center to top dead center, thus compressing the air and inputting the air into the kernel cylinder C2 of the two-stroke cycle engine unit. At this time, the intake valve V2 of the two-stroke cycle engine unit is opened, and the exhaust valve V3 repeats opening and closing operations. Further, the kernel piston P2 of the two-stroke cycle engine unit moves upwards, thus discharging the exhaust gas. Right after the exhaust valve V3 has been closed, the kernel piston P2 compresses the intake air. FIG. 7c shows the stage where the air is compressed when the intake valve V2 and the exhaust valve V3 of the two-stroke cycle engine unit are closed. In this case, the compressed air is compressed to the compression ratio required for combustion expansion. FIG. 7d shows the stage where the fuel is injected into the compressed air using the fuel injector 105. FIGS. 6a to 7k show a diesel engine as the internal-combustion engine, because the present invention is suitable for a diesel engine. FIG. 7e shows the expansion stage of the two-stroke cycle engine unit. As such, in the engine of the present invention, the fuel is burnt only in one engine unit. FIG. 7f shows the stage where the exhaust valve V3 is opened and the exhaust gas is discharged to the pressure reducing engine 200 when the kernel piston P2 of the two-stroke cycle engine unit moves upwards from bottom dead center. As soon as the exhaust valve V3 is opened, the exhaust gas is input into the pressure reducing cylinder C3 of the pressure reducing engine 200 having the comparatively larger diameter under high temperature and high pressure, thus pushing downwards the pressure reducing cylinder C3 of the pressure reducing engine 200 having the comparatively larger diameter. This is because the internal pressure of the kernel cylinder C2 of the two-stroke cycle engine unit becomes equal to that of the cylinder of the pressure reducing unit having the comparatively larger diameter when the exhaust valve V3 is opened, so that greater exhaust gas pressure acts on the piston (having the comparatively larger diameter) of the pressure reducing unit, which is larger than the diameter of the kernel piston P2 of the two-stroke cycle engine unit. This uses the principle by which kinetic energy is transferred to the movable part having the larger contact area when fluid having equal pressure acts on movable parts having different contact areas. To this end, when the kernel piston P2 of the two-stroke cycle engine unit is at the bottom dead center, the pressure reducing piston P3 of the pressure reducing engine 200 having the comparatively larger diameter must be at top dead center. Further, in this stage, the exhaust valve V4 of the pressure reducing engine 200 is closed. FIG. 7g shows that the exhaust valve V3 of the two-stroke cycle engine unit is closed, and the pressure reducing piston P3 of the pressure reducing engine 200 having the comparatively larger diameter reaches close to bottom dead center, so that explosive energy or kinetic energy of the exhaust gas is converted into rotating force. FIG. 7h shows that the exhaust valve V4 of the pressure reducing engine 200 is opened, and the pressure reducing piston P3 of the pressure reducing engine 200 having the comparatively larger diameter passes through the bottom dead center and moves toward the top dead center, thus inputting exhaust gas having high temperature and low pressure into the boiler 300. The boiler 300 heats water using the heat of the exhaust gas, thus producing vapor having high temperature and high pressure. When the intake valve V5 of the first steam engine unit is opened, vapor is input into the cylinder C4 of the first steam engine unit, thus extending the piston P4. At this time, the intake valve V6 of the second steam engine unit is closed. FIG. 7i shows the state where the piston P4 of the first steam engine unit moves to bottom dead center. FIG. 7j shows the stage where the piston P4 of the first steam engine unit moves upwards, thus inputting vapor into the cylinder C5 of the second steam engine unit having the comparatively larger diameter, when the intake valve V6 of the second steam engine unit is opened and the exhaust valve V7 is closed. In this stage, all of the expansive energy or kinetic energy of the vapor is converted into rotating force, so that only the heat remains in the vapor. FIG. 7k shows the stage where the exhaust valve V7 of the second steam engine unit is opened, and the vapor is discharged to the vapor condenser 500. At this time, heat remaining in the vapor heats and evaporates the refrigerant in the vapor condenser 500, and the evaporated refrigerant gas is input into the refrigerant gas engine again, thus generating rotating force.

When the fuel is burnt in the internal-combustion engine 100, gas pressure and heat are generated. Most of the gas pressure is converted into rotating force without loss while passing through the internal-combustion engine 100 and the pressure reducing engine 200. Only exhaust gas having high temperature and atmospheric pressure is discharged from the pressure reducing engine 200. All of the heat of the exhaust gas discharged from the pressure reducing engine 200 is converted into rotating force while passing through the boiler 300, the steam engine 400, the vapor condenser 500, and the refrigerant gas engine 600. In such a process, the pieces of insulating material 113, 115, 203, 205, 303, 403, and 407 prevent the discharge of heat from the internal-combustion engine 100 to the outside. Thus, all of the gas pressure and the heat generated when the fuel is burnt in the internal-combustion engine 100 are converted into rotating force.

As described above, the present invention provides a uniform pressure unequal surface engine and an engine for power generators using the uniform pressure unequal surface engine, which convert all of high combustion gas pressure, generated when fuel is burnt in a cylinder, into rotating force, and reduce the pressure of exhaust gas to the level of atmospheric pressure, prior to discharging the exhaust gas to the outside, thus increasing the fuel efficiency of the engine and reducing the noise and vibration of the engine, and which make a cylinder of a positive-displacement internal-combustion engine serve as a combustion chamber for an external engine as well as an explosion space, thus allowing all of the explosive pressure and thermal energy generated when the fuel is burnt to be converted into rotating force without leaking out of the engine, therefore reducing the quantity of fuel used to obtain the same power to ⅕ to ⅙ of the used quantity.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A uniform pressure unequal surface engine, comprising:
a kernel cylinder having a fuel supply unit;
a kernel piston airtightly provided in the kernel cylinder, and reciprocated by explosive force when fuel is burnt, thus providing rotating force to a rotating shaft;
a pressure reducing cylinder connected to the kernel cylinder via an openable exhaust gas pipe, having a relatively larger inner diameter than the kernel cylinder, and having no fuel supply unit;
a pressure reducing piston having a relatively larger outer diameter so as to have a larger contact area with exhaust gas compared to the kernel piston, reciprocating in the pressure reducing cylinder while remaining airtight, and obtaining power by acting with greater exhaust gas pressure on the pressure reducing piston because the pressure reducing piston has an area of contact with exhaust gas larger than that of the kernel piston when the exhaust gas pipe is opened; and
an air compressor inputting compressed air into the kernel cylinder when exhaust is being conducted from the kernel cylinder to the pressure reducing cylinder, thus pushing exhaust gas from the kernel cylinder into the pressure reducing cylinder, and providing new compressed air into the kernel cylinder.

2. The engine as set forth in claim 1, wherein a ratio of an internal capacity of the kernel cylinder when the kernel piston is at a bottom dead center to an internal capacity of the pressure reducing cylinder when the pressure reducing piston is at a bottom dead center, and a ratio of an outer diameter of the kernel piston to an outer diameter of the pressure reducing piston are set such that an internal pressure of the pressure reducing cylinder becomes equal to atmospheric pressure when the pressure reducing piston is at the bottom dead center.

3. An engine for power generators, comprising:
the uniform pressure unequal surface engine described in claim 1;
a boiler heating water using heat of exhaust gas fed from the uniform pressure unequal surface engine, thus producing vapor;
a steam engine extending a piston using pressure of the vapor fed from the boiler; and
a vapor condenser collecting the vapor of the steam engine and condensing the vapor using refrigerant, prior to feeding the vapor back to the boiler.

4. An engine for power generators, comprising:
the uniform pressure unequal surface engine described in claim 2;
a boiler heating water using heat of exhaust gas fed from the uniform pressure unequal surface engine, thus producing vapor;
a steam engine extending a piston using pressure of the vapor fed from the boiler; and
a vapor condenser collecting the vapor of the steam engine and condensing the vapor using refrigerant, prior to feeding the vapor back to the boiler.

5. The engine for power generators as set forth in claim 3, wherein the refrigerant of the vapor condenser uses liquid having a lower boiling point than water, and a refrigerant gas engine is further connected to the vapor condenser and extends a piston using pressure of refrigerant gas which is evaporated by absorbing latent heat of condensation in the vapor condenser.

6. The engine for power generators as set forth in claim 4, wherein the refrigerant of the vapor condenser uses liquid having a lower boiling point than water, and a refrigerant gas engine is further connected to the vapor condenser and extends a piston using pressure of refrigerant gas which is evaporated by absorbing latent heat of condensation in the vapor condenser.

7. The engine for power generators as set forth in claim 3, wherein an internal-combustion engine comprises:
a two-stroke cycle engine unit injecting fuel into compressed air in a cylinder every two strokes, thus extending a piston using explosive force when the fuel is burnt; and
an air compressor unit drawing external air through an intake pipe into the cylinder every two strokes, and compressing the air using the piston, thus inputting the compressed air into the two-stroke cycle engine unit.

8. The engine for power generators as set forth in claim 4 wherein an internal-combustion engine comprises:
a two-stroke cycle engine unit injecting fuel into compressed air in a cylinder every two strokes, thus extending a piston using explosive force when the fuel is burnt; and
an air compressor unit drawing external air through an intake pipe into the cylinder every two strokes, and compressing the air using the piston, thus inputting the compressed air into the two-stroke cycle engine unit.

9. The engine for power generators as set forth in claim 5, wherein an internal-combustion engine comprises:
a two-stroke cycle engine unit injecting fuel into compressed air in a cylinder every two strokes, thus extending a piston using explosive force when the fuel is burnt; and
an air compressor unit drawing external air through an intake pipe into the cylinder every two strokes, and compressing the air using the piston, thus inputting the compressed air into the two-stroke cycle engine unit.

10. The engine for power generators as set forth in claim 3, wherein the steam engine comprises:
a first steam engine unit opening an intake valve every two strokes, and extending a piston using the vapor fed from the boiler to the cylinder; and
a second steam engine unit extending a piston having a relatively larger diameter using the vapor which is discharged from the first steam engine unit and is fed into a cylinder, in a principle using uniform pressure and unequal surfaces.

11. The engine for power generators as set forth in claim 4, wherein the steam engine comprises:
a first steam engine unit opening an intake valve every two strokes, and extending a piston using the vapor fed from the boiler to the cylinder; and
a second steam engine unit extending a piston having a relatively larger diameter using the vapor which is discharged from the first steam engine unit and is fed into a cylinder, in a principle using uniform pressure and unequal surfaces.

12. The engine for power generators as set forth in claim 5, wherein the steam engine comprises:
a first steam engine unit opening an intake valve every two strokes, and extending a piston using the vapor fed from the boiler to the cylinder; and
a second steam engine unit extending a piston having a relatively larger diameter using the vapor which is discharged from the first steam engine unit and is fed into a cylinder, in a principle using uniform pressure and unequal surfaces.

13. The engine for power generators as set forth in claim 3, wherein the refrigerant gas engine comprises:
a first refrigerant gas engine unit opening an intake valve every two strokes and extending a piston using refrigerant gas fed from a condensing tank of the vapor condenser to a cylinder; and
a second refrigerant gas engine unit extending a piston having a relatively larger diameter using refrigerant gas fed from the first refrigerant gas engine unit into the cylinder, in a principle using uniform pressure and unequal surfaces.

14. The engine for power generators as set forth in claim 4, wherein the refrigerant gas engine comprises:
a first refrigerant gas engine unit opening an intake valve every two strokes and extending a piston using refrigerant gas fed from a condensing tank of the vapor condenser to a cylinder; and
a second refrigerant gas engine unit extending a piston having a relatively larger diameter using refrigerant gas fed from the first refrigerant gas engine unit into the cylinder, in a principle using uniform pressure and unequal surfaces.

15. The engine for power generators as set forth in claim 5, wherein the refrigerant gas engine comprises:
a first refrigerant gas engine unit opening an intake valve every two strokes and extending a piston using refrigerant gas fed from a condensing tank of the vapor condenser to a cylinder; and
a second refrigerant gas engine unit extending a piston having a relatively larger diameter using refrigerant gas fed from the first refrigerant gas engine unit into the cylinder, in a principle using uniform pressure and unequal surfaces.
